(19) United States
(12) Patent Application Publication
(10) Pub. No.: US 2025/0158773 A1
(43) Pub. Date: May 15, 2025

(54) CONFIGURATIONS AND OPERATIONS RELATED TO SOUNDING REFERENCE SIGNALS

(71) Applicant: Nokia Technologies Oy, Espoo (FI)

(72) Inventors: Matha DEGHEL, Paris (FR); Youngsoo YUK, Seoul (KR)

(73) Assignee: Nokia Technologies Oy, Espoo (FI)

(21) Appl. No.: 18/837,323

(22) PCT Filed: Feb. 11, 2022
(86) PCT No.: PCT/EP2022/053346

§ 371 Date: Aug. 9, 2024

(51) Int. Cl. H04L 5/00; H04W 52/14; H04W 72/1268

(52) U.S. Cl. CPC H04L 5/0051; H04L 5/0044; H04W 52/146; H04W 72/1268

(57) ABSTRACT

There is provided an apparatus comprising means for: receiving a configuration related to sounding reference signal resources comprising a first sounding reference signal resource group and a second sounding reference signal resource group, wherein the first sounding reference signal resource group is associated to a first waveform and the second sounding reference signal resource group is associated to a second waveform different from the first waveform.

### FIELD

Various example embodiments relate to configurations and operations related to sounding reference signals.

### BACKGROUND

In long term evolution (LTE) networks, cyclic prefix orthogonal frequency division multiplexing (CP-OFDM) waveform is used for downlink transmissions and discrete Fourier transform Spread OFDM (DFT-S-OFDM) waveform for uplink transmissions. In new radio (NR) 5G, both CP-OFDM and DFT-S-OFDM, may be used in uplink traffic.

### SUMMARY

According to some aspects, there is provided the subject-matter of the independent claims. Some example embodiments are defined in the dependent claims. The scope of protection sought for various example embodiments is set out by the independent claims. The example embodiments and features, if any, described in this specification that do not fall under the scope of the independent claims are to be interpreted as examples useful for understanding various example embodiments.

According to a first aspect, there is provided an apparatus comprising means for: receiving a configuration related to sounding reference signal resources comprising a first sounding reference signal resource group and a second sounding reference signal resource group, wherein the first sounding reference signal resource group is associated to a first waveform and the second sounding reference signal resource group is associated to a second waveform different from the first waveform.

According to a second aspect, there is provided a method comprising: receiving, by a user equipment from a network node, a configuration related to sounding reference signal resources comprising a first sounding reference signal resource group and a second sounding reference signal resource group, wherein the first sounding reference signal resource group is associated to a first waveform and the second sounding reference signal resource group is associated to a second waveform different from the first waveform.

According to a third aspect, there is provided a non-transitory computer readable medium comprising program instructions that, when executed by at least one processor, cause an apparatus to at least to perform the method of the second aspect and any of the embodiments thereof.

According to a fourth aspect, there is provided a computer program configured to cause an apparatus to perform the method of the second aspect and any of the embodiments thereof, when run by the apparatus.

According to a fifth aspect, there is provided an apparatus comprising means for: transmitting a configuration related to sounding reference signal resources comprising a first sounding reference signal resource group and a second sounding reference signal resource group, wherein the first sounding reference signal resource group is associated to a first waveform and the second sounding reference signal resource group is associated to a second waveform different from the first waveform.

According to a sixth aspect, there is provided a method comprising: transmitting, by a network node to a user equipment, a configuration related to sounding reference signal resources comprising a first sounding reference signal resource group and a second sounding reference signal resource group, wherein the first sounding reference signal resource group is associated to a first waveform and the second sounding reference signal resource group is associated to a second waveform different from the first waveform.

According to a seventh aspect, there is provided a non-transitory computer readable medium comprising program instructions that, when executed by at least one processor, cause an apparatus to at least to perform the method of the sixth aspect and any of the embodiments thereof.

According to a fourth aspect, there is provided a computer program configured to cause an apparatus to perform the method of the sixth aspect and any of the embodiments thereof, when run by the apparatus.

According to a further aspect, there is provided an apparatus comprising at least one processor; and at least one memory including computer program code, the at least one memory and the computer program code configured to, with the at least one processor, cause the apparatus to perform at least: receiving a configuration related to sounding reference signal resources comprising a first sounding reference signal resource group and a second sounding reference signal resource group, wherein the first sounding reference signal resource group is associated to a first waveform and the second sounding reference signal resource group is associated to a second waveform different from the first waveform.

According to a further aspect, there is provided an apparatus comprising at least one processor; and at least one memory including computer program code, the at least one memory and the computer program code configured to, with the at least one processor, cause the apparatus to perform at least: transmitting a configuration related to sounding reference signal resources comprising a first sounding reference signal resource group and a second sounding reference signal resource group, wherein the first sounding reference signal resource group is associated to a first waveform and the second sounding reference signal resource group is associated to a second waveform different from the first waveform.

### BRIEF DESCRIPTION OF THE DRAWINGS

FIG. 1 shows, by way of example, a network architecture of communication system;

FIG. 2 shows, by way of example, a flowchart of a method;

FIG. 3 shows, by way of example, a flowchart of a method;

FIG. 4 shows, by way of example, signalling between user equipment and network node;

FIG. 5 shows, by way of example, signalling between user equipment and network node;

FIG. 6 shows, by way of example, signalling between user equipment and

network node;

FIG. 7 shows, by way of example, sounding reference signal resource bandwidth adaptation; and

FIG. 8 shows, by way of example, a block diagram of an apparatus.

### DETAILED DESCRIPTION

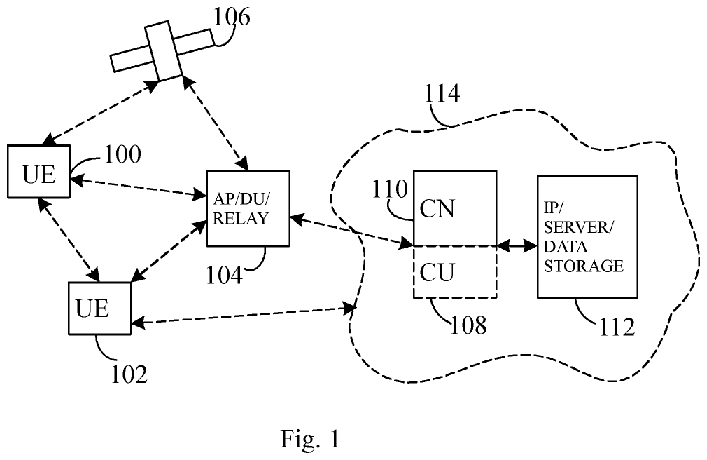

FIG. 1 shows, by way of an example, a network architecture of communication system. In the following, different exemplifying embodiments will be described using, as an example of an access architecture to which the embodiments may be applied, a radio access architecture based on long term evolution advanced (LTE Advanced, LTE-A) or new radio (NR), also known as fifth generation (5G), without restricting the embodiments to such an architecture, however. It is obvious for a person skilled in the art that the embodiments may also be applied to other kinds of communications networks having suitable means by adjusting parameters and procedures appropriately. Some examples of other options for suitable systems are the universal mobile telecommunications system (UMTS) radio access network (UTRAN or E-UTRAN), long term evolution (LTE, the same as E-UTRA), wireless local area network (WLAN or WiFi), worldwide interoperability for microwave access (WiMAX), Bluetooth®, personal communications services (PCS), ZigBee®, wideband code division multiple access (WCDMA), systems using ultra-wideband (UWB) technology, sensor networks, mobile ad-hoc networks (MANETs) and Internet Protocol multimedia subsystems (IMS) or any combination thereof.

The example of FIG. 1 shows a part of an exemplifying radio access network. FIG. 1 shows user devices 100 and 102 configured to be in a wireless connection on one or more communication channels in a cell with an access node, such as gNB, i.e. next generation NodeB, or eNB, i.e. evolved NodeB (eNodeB), 104 providing the cell. The physical link from a user device to the network node is called uplink (UL) or reverse link and the physical link from the network node to the user device is called downlink (DL) or forward link. It should be appreciated that network nodes or their functionalities may be implemented by using any node, host, server or access point etc. entity suitable for such a usage. A communications system typically comprises more than one network node in which case the network nodes may also be configured to communicate with one another over links, wired or wireless, designed for the purpose. These links may be used for signalling purposes. The network node is a computing device configured to control the radio resources of the communication system it is coupled to. The network node may also be referred to as a base station (BS), an access point or any other type of interfacing device including a relay station capable of operating in a wireless environment. The network node includes or is coupled to transceivers. From the transceivers of the network node, a connection is provided to an antenna unit that establishes bi-directional radio links to user devices. The antenna unit may comprise a plurality of antennas or antenna elements. The network node is further connected to core network 110 (CN or next generation core NGC). Depending on the system, the counterpart on the CN side can be a serving gateway (S-GW, routing and forwarding user data packets), packet data network gateway (P-GW), for providing connectivity of user devices (UEs) to external packet data networks, or mobile management entity (MME), etc. An example of the network node configured to operate as a relay station is integrated access and backhaul node (IAB). The distributed unit (DU) part of the IAB node performs BS functionalities of the IAB node, while the backhaul connection is carried out by the mobile termination (MT) part of the IAB node. UE functionalities may be carried out by IAB MT, and BS functionalities may be carried out by IAB DU. Network architecture may comprise a parent node, i.e. IAB donor, which may have wired connection with the CN, and wireless connection with the IAB MT.

The user device, or user equipment UE, typically refers to a portable computing device that includes wireless mobile communication devices operating with or without a subscriber identification module (SIM), including, but not limited to, the following types of devices: a mobile station (mobile phone), smartphone, personal digital assistant (PDA), handset, device using a wireless modem (alarm or measurement device, etc.), laptop and/or touch screen computer, tablet, game console, notebook, and multimedia device. It should be appreciated that a user device may also be a nearly exclusive uplink only device, of which an example is a camera or video camera loading images or video clips to a network. A user device may also be a device having capability to operate in Internet of Things (IoT) network which is a scenario in which objects are provided with the ability to transfer data over a network without requiring human-to-human or human-to-computer interaction.

Additionally, although the apparatuses have been depicted as single entities, different units, processors and/or memory units (not all shown in FIG. 1) may be implemented inside these apparatuses, to enable the functioning thereof.

5G enables using multiple input-multiple output (MIMO) technology at both UE and gNB side, many more base stations or nodes than the LTE (a so-called small cell concept), including macro sites operating in co-operation with smaller stations and employing a variety of radio technologies depending on service needs, use cases and/or spectrum available. 5G mobile communications supports a wide range of use cases and related applications including video streaming, augmented reality, different ways of data sharing and various forms of machine type applications (such as (massive) machine-type communications (mMTC), including vehicular safety, different sensors and real-time control. 5G is expected to have multiple radio interfaces, namely below 7 GHz, cmWave and mmWave, and also being integratable with existing legacy radio access technologies, such as the LTE. Below 7 GHz frequency range may be called as FR1, and above 24 GHz (or more exactly 24-52.6 GHz) as FR2, respectively. Integration with the LTE may be implemented, at least in the early phase, as a system, where macro coverage is provided by the LTE and 5G radio interface access comes from small cells by aggregation to the LTE. In other words, 5G is planned to support both inter-RAT operability (such as LTE-5G) and inter-RI operability (inter-radio interface operability, such as below 7 GHz—cmWave, below 7 GHz—cmWave—mmWave). One of the concepts considered to be used in 5G networks is network slicing in which multiple independent and dedicated virtual sub-networks (network instances) may be created within the same infrastructure to run services that have different requirements on latency, reliability, throughput and mobility.

The communication system is also able to communicate with other networks, such as a public switched telephone network or the Internet 112, or utilize services provided by them. The communication network may also be able to support the usage of cloud services, for example at least part of core network operations may be carried out as a cloud service (this is depicted in FIG. 1 by “cloud” 114). The communication system may also comprise a central control entity, or a like, providing facilities for networks of different operators to cooperate for example in spectrum sharing.

Edge cloud may be brought into radio access network (RAN) by utilizing network function virtualization (NVF) and software defined networking (SDN). Using edge cloud may mean access node operations to be carried out, at least partly, in a server, host or node operationally coupled to a remote radio head or base station comprising radio parts. It is also possible that node operations will be distributed among a plurality of servers, nodes or hosts. Application of cloud RAN architecture enables RAN real time functions being carried out at the RAN side (in a distributed unit, DU 104) and non-real time functions being carried out in a centralized manner (in a centralized unit, CU 108).

5G may also utilize satellite communication to enhance or complement the coverage of 5G service, for example by providing backhauling. Possible use cases are providing service continuity for machine-to-machine (M2M) or Internet of Things (IoT) devices or for passengers on board of vehicles, or ensuring service availability for critical communications, and future railway/maritime/aeronautical communications. Satellite communication may utilise geostationary earth orbit (GEO) satellite systems, but also low earth orbit (LEO) satellite systems, in particular mega-constellations (systems in which hundreds of (nano) satellites are deployed). Each satellite 106 in the constellation may cover several satellite-enabled network entities that create on-ground cells. The on-ground cells may be created through an on-ground relay node 104 or by a gNB located on-ground or in a satellite.

A UE may be configured in two different modes for physical uplink shared channel (PUSCH) multi-antenna precoding, namely codebook-based transmission and non-codebook-based transmission.

For codebook-based dynamic grant (DG) PUSCH, the UE determines sounding reference signal (SRS) resource indicator SRI and transmit precoding-matrix indicator (TPMI) information (via precoding information and number of layers) from the corresponding fields in downlink control information (DCI). The SRI provides the UL beam information (in FR2), and TPMI provides UL precoder information.

For non-codebook-based DG PUSCH, in contrast to codebook-based mode, the UE determines its precoder and transmission rank based on downlink measurements. However, the UE selection of a precoder and the number of layers for the scheduled PUSCHs may be modified by the network, in case multiple SRS resources are configured, by omitting some columns from the precoder that the UE has selected. Omission of some columns from the precoder may be performed by indicating, via SRI contained in DCI scheduling the PUSCH, a subset of the configured SRS resources.

SRS is a reference signal transmitted by the UE in the UL direction. The network node may use the SRS to estimate the uplink channel quality and use this information for uplink scheduling.

SRSs may be configured, for example via radio resource control (RRC) configuration, within an SRS resource set comprising one or more SRS resources. This configuration mechanism simplifies the activation (for semi-persistent SRS) and DCI triggering (for aperiodic SRS), since multiple resources may be triggered simultaneously. Several use cases have been identified for SRS, and thus the RRC configuration of an SRS resource set contains a parameter called “usage”. Usage parameter may be, for example, antennaSwitching, codebook, nonCodebook, or beamManagement.

The SRS supports up to 4 antenna ports, and it is designed to have low cubic metric, enabling efficient operation of the high-power amplifier. In general, the SRS can span 1, 2, or 4 consecutive orthogonal frequency division multiplexing (OFDM) symbols within the last six symbols of a slot. In the frequency domain, an SRS occasion has a comb structure where the SRS is transmitted on every Nth subcarrier, where N=2 or 4, referred to as comb-2 or comb-4. The SRS transmissions from different UEs can be frequency-multiplexed within the same frequency range using different comb patterns corresponding to different frequency offsets. For comb-2, that is, transmitting SRS on every other subcarrier, two SRSs can be frequency multiplexed. For comb-4, that is, transmitting SRS on every fourth subcarrier, up to four SRSs can be frequency multiplexed.

The SRS may be configured as periodic, semi-persistent, or aperiodic transmission. A periodic SRS is transmitted with a certain configured periodicity and a certain configured slot offset within that period. A semi-persistent SRS has a configured periodicity and slot offset in the same way as a periodic SRS. However, the SRS transmission is performed according to the configured periodicity and slot offset that is activated or deactivated via MAC control element signaling. An aperiodic SRS is transmitted when explicitly triggered via DCI. It is noted that SRS activation/deactivation or triggering for semi-persistent and aperiodic cases is not done for a specific SRS, but rather for an SRS resource set which may include one or more SRS resources.

The bandwidth (BW) configuration of an SRS resource may be controlled by the RRC parameters C_{SRS}, n_{shift}, B_{SRS}, bₕₒₚ, and n_{RRC}. These parameters define which portion of a bandwidth part (BWP) is sounded by an SRS resource. The parameter C_{SRS}∈{0, 1, . . . , 63} selects a bandwidth configuration for the SRS resource corresponding to a particular row of Table 6.4.1.4.3-1 in TS 38.211. For partial BWP sounding, the position of the maximum sounding bandwidth within the BWP is determined by the parameter n_{shift} which determines the index of the first PRB of the maximum sounding bandwidth.

The parameter B_{SRS} of the SRS bandwidth configuration controls whether all or a subset of the PRBs in the actual sounding bandwidth are used either (i) by hopping over a number of smaller BW allocations in different OFDM symbols, or (ii) by a fixed (non-hopped) BW allocation. For frequency hopped SRS, the frequency domain starting position of each hop varies over time according to a pre-defined hopping pattern, whereas for non-hopped SRS the frequency domain starting position is fixed over time. The relationship between B_{SRS} and bₕₒₚ determines whether frequency hopping is enabled or disabled. The position of the actual sounding bandwidth within the maximum is determined by the parameter n_{RRC} which has a configurable range of 0 . . . 67.

The sequences applied to the set of SRS resource elements may be partly based on Zadoff-Chu sequences. In the case of an SRS supporting more than one antenna port, the different ports share the same set of resource elements and the same basic SRS sequence. Different phase rotations may then be applied to separate the different ports. Applying a phase rotation in the frequency domain is equivalent to applying a cyclic shift in the time domain.

If aperiodic SRS is configured for a UE, the SRS request field in DCI triggers the transmission of aperiodic SRS resources. SRS request field may be present e.g. in UL DCI format (such as 0_1 and 0_2) and DL DCI format (such as 1_1 and 1_2).

Aperiodic SRS triggering has been enhanced by adding a DCI field “t” for dynamic triggering offset adaptation in DCI formats 0_1 and 1_1 without CSI and data scheduling, and RRC configured parameter “t”, comprising 4 values, for UL SRS resource sets, e.g. for each UL SRS resource set. In addition, SRS switching has been specified for up to 8 antennas, for example, xTyR, wherein x={1, 2, 4} and y={6, 8}. Further, following mechanism(s) has/have been specified to improve SRS capacity and/or coverage: SRS time bundling, increased SRS repetition, and partial sounding across frequency.

In 5G NR, PUSCH power control is based on a combination of open-loop power control and closed loop power control. Open-loop power control includes support for fractional path-loss compensation, where the UE estimates the UL path-loss based on DL measurements and sets the transmit power accordingly.

Closed-loop power control is based on explicit transmit power-control (TPC) commands provided by the network.

The UE may determine the PUSCH transmission power based on the procedures described in Section 7.1 of TS 38.213. In summary, the UE is indicated or the UE determines closed-loop parameters, e.g. closed-loop index, TPC command, and open-loop parameters, e.g. pathloss reference signal RS, p0, alpha. The TPC command is carried in the DCI scheduling the PUSCH transmission. TPC command and corresponding closed-loop index may be carried jointly to multiple UEs by a group-common DCI using DCI format 2-2.

Hence, the main power control parameters on which the PUSCH transmission power depends are: closed-loop index (also known as PC adjustment state), TPC command (f_{b,f,c}, absolute or accumulative TPC command), pathloss reference signal RS, p0 (also denoted as P_{0_UE_PUSCH}), alpha (for partial or full path-loss compensation). These parameters are defined and explained in Section 7.1.1 of TS 38.213.

The PUSCH configuration contains PUSCH-PowerControl which is used to configure UE specific power control parameter for PUSCH. PUSCH-PowerControl includes a SRI-PUSCH-PowerControl, that is, a list of SRI-PUSCH-PowerControl elements among which one is selected by the SRI field in DCI. The SRI-PUSCH-PowerControl field includes at least p0, alpha, closed-loop index, and pathloss reference signal RS.

Cyclic prefix orthogonal frequency division multiplexing (CP-OFDM) waveform is used in DL traffic in 5G, and both CP-OFDM and discrete Fourier transform spread orthogonal frequency division multiplexing (DFT-S-OFDM) waveforms are used in UL traffic. The network is configured to decide which of the two waveforms is to be used in the uplink.

In some occasions, there might be a need to dynamically switch between DFT-S-OFDM and CP-OFDM. For example, DFT-S-OFDM waveform is beneficial for UL coverage limited scenario because of its lower peak-to-average power ratio (PAPR) compared to CP-OFDM waveform. If UL waveform is configured via RRC, which considers a single applicable waveform at a time, it imposes a large barrier to switch from CP-OFDM to DFT-S-OFDM, for example for cell-edge UEs.

Different waveforms have different requirements and considerations in terms of, for example, frequency and time domain allocations, power allocation, etc. For example, DFT-S-OFDM is more suitable in case of a power limited scenario. When dynamically switching between DFT-S-OFDM and CP-OFDM, it is desirable to configure the UE in a waveform dependent manner. For example, it is desirable to configure some parameters/sets/configurations in a waveform dependent manner.

Methods are provided for configuring the UE with SRS resources that are waveform dependent, or specific to a given waveform, e.g. DFT-S-OFDM or CP-OFDM.

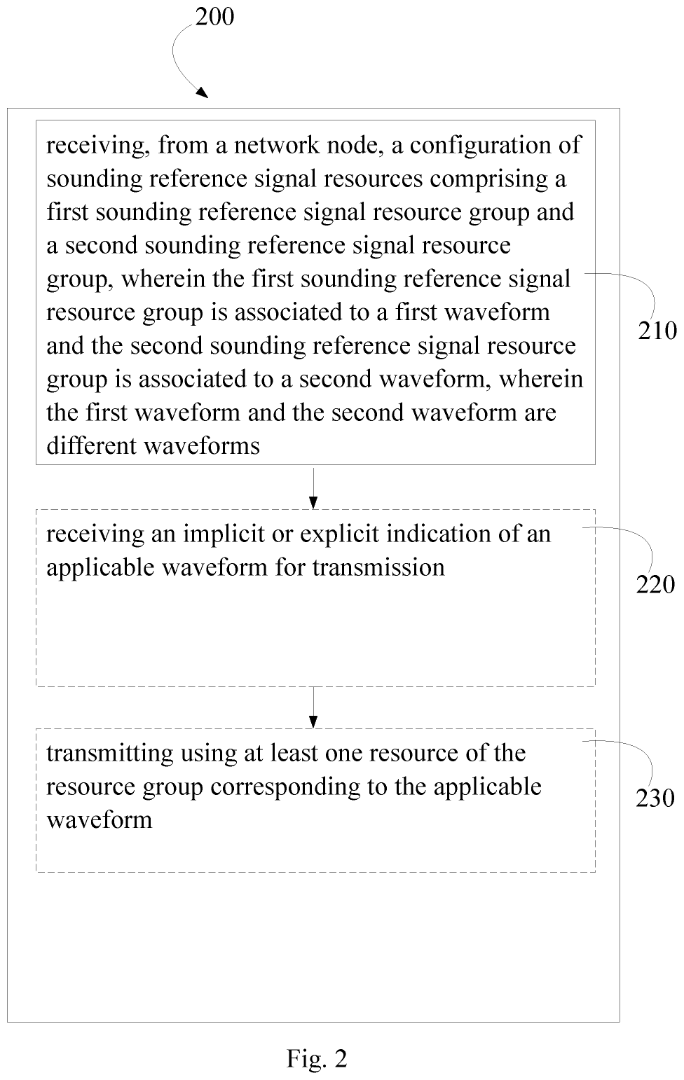

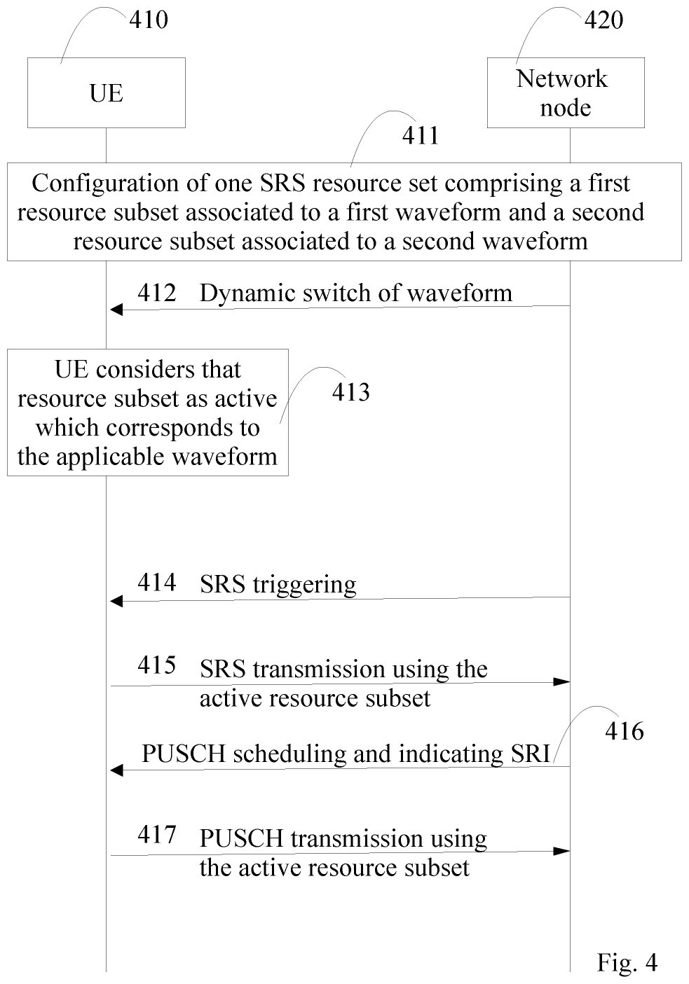

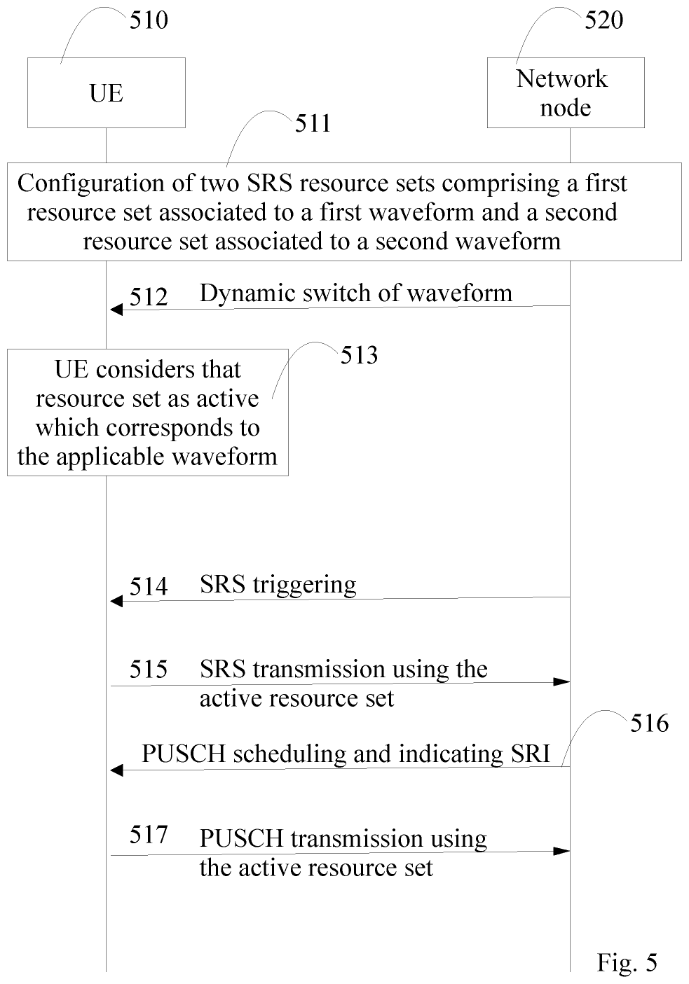

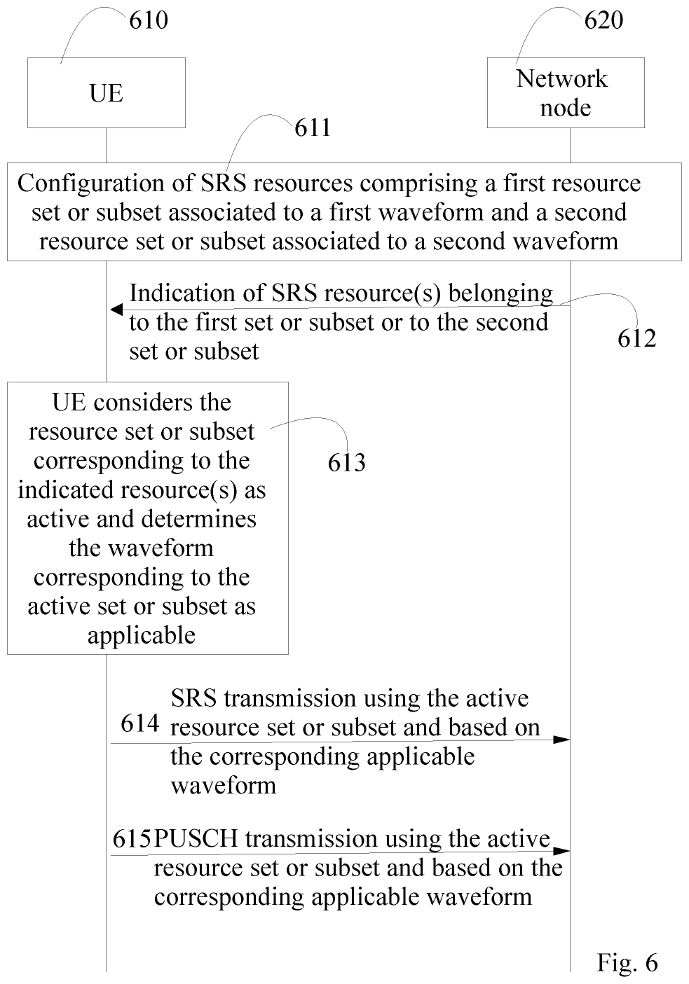

FIG. 2 shows, by way of example, a flowchart of a method. The method 200 may be performed by UE, such as UE 410 of FIG. 4, UE 510 of FIG. 5, or UE 610 of FIG. 6. The method 200 comprises receiving 210 a configuration of sounding reference signal resources comprising a first sounding reference signal resource group and a second sounding reference signal resource group, wherein the first sounding reference signal resource group is associated to a first waveform and the second sounding reference signal resource group is associated to a second waveform, wherein the first waveform and the second waveform are different waveforms. The group may be a resource set or a subset, as explained in the context of the FIG. 4 and FIG. 5.

The method 200 may comprise receiving 220 an implicit or explicit indication of an applicable waveform for transmission.

The method 200 may comprise transmitting 230 using the resource group corresponding to the applicable waveform.

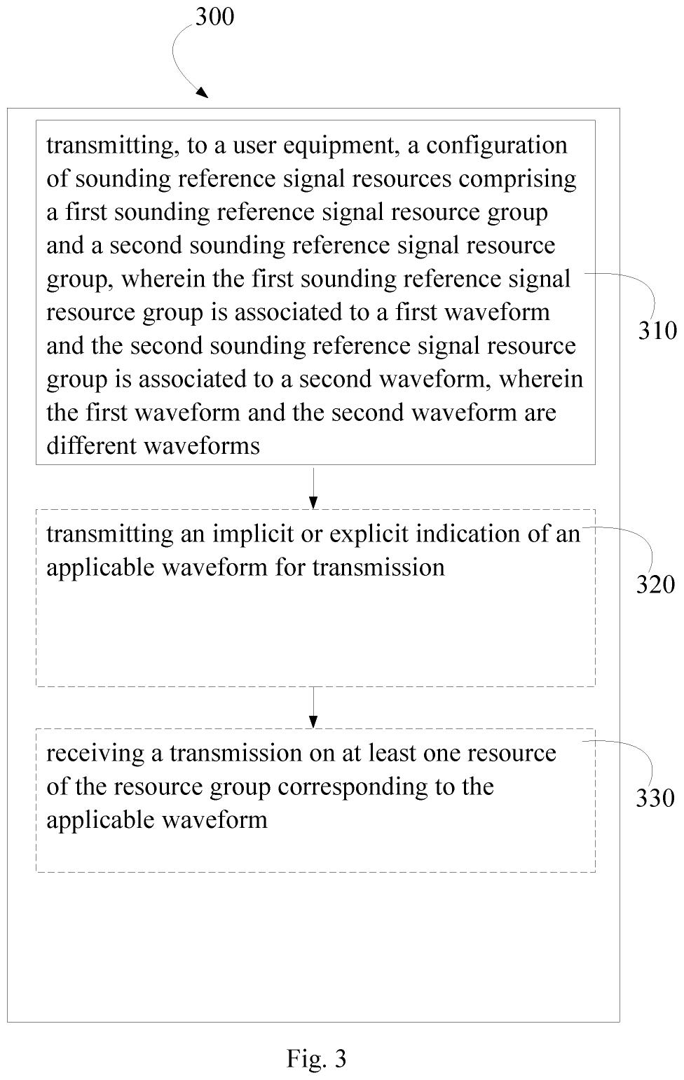

FIG. 3 shows, by way of example, a flowchart of a method. The method may be performed by a network node, e.g. gNB, such as the network node 420 of FIG. 4, network node 520 of FIG. 5, or network node 620 of FIG. 6. The method 300 comprises transmitting 310 a configuration of sounding reference signal resources comprising a first sounding reference signal resource group and a second sounding reference signal resource group, wherein the first sounding reference signal resource group is associated to a first waveform and the second sounding reference signal resource group is associated to a second waveform, wherein the first waveform and the second waveform are different waveforms.

The method 300 may comprise transmitting 320 an implicit or explicit indication of an applicable waveform for transmission.

The method 300 may comprise receiving 330 a transmission on the resource group corresponding to the applicable waveform.

The methods as disclosed herein enable waveform dependent SRS triggering and transmission. The methods as disclosed herein enable dynamic switching between the waveforms via indicated SRS resource(s). The methods as disclosed herein enable SRS bandwidth adaptation when dynamically switching between the waveforms.

FIG. 4 shows, by way of example, signalling between user equipment UE 410 and network node 420, e.g. gNB. The network node configures 411 the UE with SRS resources. For example, a single resource set comprises at least two resource groups or subsets, a first resource subset and a second resource subset. The first resource subset is associated to the first waveform, e.g. DFT-S-OFDM. The second resource subset is associated to the second waveform, e.g. CP-OFDM.

Different configurations may be performed for different usages of SRSs. Examples of usages are antenna switching, codebook, noncodebook, and beam management. Also, SRSs may be SRS positioning resources.

An SRS resource may be allowed to belong to two different SRS resource subsets, i.e. the two resource subsets are not mutually exclusive. Alternatively, the two resource subsets may be mutually exclusive, i.e. an SRS resource might not be allowed to belong to two different SRS resource subsets.

The UE 410 receives 412 an indication of an applicable waveform for transmission. This indication may be considered as an explicit indication of the applicable waveform for transmission. A waveform may be identified by using a corresponding index, for example. Parameter “transform precoding” TP may be set to enabled, which indicates a configuration to DFT-S-OFDM. Associating a configuration to CP-OFDM may be performed by including the TP parameter set to disabled. It is noted that explicit (or even implicit) indication of waveform may be acknowledged by the UE (implicitly or explicitly), in which case the indicated waveform might not become applicable before the acknowledgement is transmitted. Additionally, or alternatively, the indicated waveform may be applicable after a certain application time period after the indication reception or after the acknowledgement transmission (if any).

For example, the network node 420 may dynamically switch 412 the waveform between DFT-S-OFDM and CP-OFDM. The indication may be received, for example, via MAC CE or DCI. Indication of the applicable waveform may be e.g. an indication to transmit using the SRS resource subset, which corresponds to the applicable waveform.

The UE 410 considers 413 that one SRS resource subset as active (or applicable), which corresponds to the applicable waveform. If the first waveform is the applicable waveform, the UE considers the first SRS resource subset as active. If the second waveform is the applicable waveform, the UE considers the second SRS resource subset as active. This impacts the following SRS transmission(s) and PUSCH transmission(s) through SRI indication, and SRI-based PUSCH power control.

The network node 420 may trigger 414, or active, the SRS resource set, e.g. via DCI. The triggered, or activated, subset may correspond to the current applicable waveform, which has been indicated to the UE. Alternatively, the network node 420 may indicate, e.g. via DCI and/or MAC CE, the UE whether to transmit using the SRS resource subset corresponding to the current applicable waveform, or the other SRS resource subset corresponding to another waveform. That is, the waveform may be switched along with the triggering 414.

The network node 420 may also indicate to the UE whether to transmit using the entire SRS resource set or using one of the resource subsets. This indication may be performed, for example, via DCI, MAC CE or RRC.

The UE 410 may transmit 415 the triggered SRSs using the active SRS resource subset. It is noted that there may be one or more semi-persistent and/or periodic SRS(s) activated or configured, which may correspond, or be associated, to one or more waveforms, e.g. two or more different waveforms. In this latter case, the UE may transmit, e.g. only transmit, the SRS(s) that corresponds to the (current) applicable waveform; and the UE might not transmit the SRS(s) that corresponds to the other waveform(s). It is also noted that, the term ‘activated’ or ‘activation’ may also be used to cover the periodic SRS case, where the ‘activation’ in this case may refer to receiving a configuration of the periodic SRS.

The network node 420 may schedule 416 PUSCH transmission and indicate the SRS resources (i.e. one or more SRS resources) via SRS resource indicator, SRI. The SRI values or entries, e.g. indicated via UL DCI, may point to the one or more SRS resources belonging to the SRS resource subset corresponding to the current applicable waveform. Thus, the UE receives scheduling information for the PUSCH transmission and an indication related to at least one SRS resource comprised in the active SRS resource subset.

The UE 410 may transmit 417 the scheduled PUSCH transmission using/considering the active, or applicable, SRS resource subset. The UE may transmit the PUSCH transmission with the one or more SRS resources indicated in the SRI.

A list or a sub-list of power control elements, e.g. SRI-based PUSCH power control (represented by SRI-PUSCH-PowerControl) elements, may be configured for the waveform, e.g. as part of the PUSCH power control configuration. For the determination of SRI-based PUSCH power control parameters, such as P0, alpha, closed-loop index, pathloss reference signal RS, the UE may use the list corresponding the current applicable waveform. Alternatively, or additionally, in case unified transmission configuration indicator (TCI) framework is configured/applicable, a TCI state (joint TCI state or separate UL TCI state) may include or be associated with two sets/subsets of (closed-loop and/or open-loop) power control parameters where each set/subset may correspond to a waveform. Thus, for an indicated TCI state and a given applicable waveform, the corresponding set/subset of power control parameters is applicable (for PUSCH/SRS transmission(s)).

For example, the association or mapping between the list of SRI-based PUSCH power control elements to a waveform may be performed through associating this list to the SRS resource subset corresponding to this waveform.

SRS resources belonging to different subsets may then have different parameters or values corresponding to different waveforms such as time domain allocation, frequency domain allocation, bandwidth related parameters, sequence related parameters (such as base sequence, cyclic shift(s)), power related parameters (such as open-loop and closed-loop parameters), time bundling related parameters, SRS repetition parameters, partial-sounding-across-frequency parameters, number of (SRS) ports, etc.

FIG. 5 shows, by way of example, signalling between user equipment UE 510 and network node 520, e.g. gNB. The network node configures 511 the UE with SRS resources. For example, two resource sets comprises a first resource set or group and a second resource set or group. The first resource set is associated to the first waveform, e.g. DFT-S-OFDM. The second resource set is associated to the second waveform, e.g. CP-OFDM.

Different configurations may be performed for different usages of SRSs. Examples of usages are antenna switching, codebook, noncodebook, and beam management.

An SRS resource may be allowed to belong to two different SRS resource sets, i.e. the two resource sets are not mutually exclusive. Alternatively, the two resource sets may be mutually exclusive, i.e. an SRS resource might not be allowed to belong to two different SRS resource sets.

The UE 510 receives 512 an indication of an applicable waveform for transmission. This indication may be considered as an explicit indication of the applicable waveform for transmission. A waveform may be identified by using a corresponding index, for example. Parameter “transform precoding” TP may be set to enabled, which indicates a configuration to DFT-S-OFDM. Associating a configuration to CP-OFDM may be performed by including the TP parameter set to disabled.

For example, the network node 520 may dynamically switch 512 the waveform between DFT-S-OFDM and CP-OFDM. The indication may be received, for example, via MAC CE or DCI. Indication of the applicable waveform may be e.g. an indication to transmit using the SRS resource set, which corresponds to the applicable waveform.

The UE 510 considers 513 that one SRS resource set as active (or applicable), which corresponds to the applicable waveform. If the first waveform is the applicable waveform, the UE considers the first SRS resource set as active. If the second waveform is the applicable waveform, the UE considers the second SRS resource set as active. This impacts the following SRS transmission(s) and PUSCH transmission(s) through SRI indication, and SRI-based PUSCH power control.

The network node 520 may trigger 514, or activate, the SRS resource set, e.g. via DCI. The triggered, or activated, set may correspond to the current applicable waveform, which has been indicated to the UE. Alternatively, the network node 520 may indicate, e.g. via DCI and/or MAC CE, the UE whether to transmit using the SRS resource set corresponding to the current applicable waveform, or the other SRS resource set corresponding to another waveform. That is, the waveform may be switched along with the triggering 514.

The UE 510 may transmit 515 the triggered SRSs using the active SRS resource set. It is noted that there may be one or more semi-persistent and/or periodic SRS(s) activated or configured, which may correspond, or be associated, to one or more waveforms, e.g. two or more different waveforms. In this latter case, the UE may transmit, e.g. only transmit, the SRS(s) that corresponds to the (current) applicable waveform; and the UE might not transmit the SRS(s) that corresponds to the other waveform(s). It is also noted that, the term ‘activated’ or ‘activation’ may also be used to cover the periodic SRS case, where the ‘activation’ (or ‘activated’) for periodic SRS in this case may refer to receiving a configuration of the periodic SRS.

The network node 520 may schedule 516 PUSCH transmission and indicate the SRS resources (i.e. one or more SRS resources) via SRS resource indicator, SRI. The SRI values or entries, e.g. indicated via UL DCI, may point to the one or more SRS resources belonging to the SRS resource set corresponding to the current applicable waveform. Thus, the UE receives scheduling information for the PUSCH transmission and an indication related to at least one SRS resource comprised in the active SRS resource set.

The UE 510 may transmit 517 the scheduled PUSCH transmission using the active, or applicable, SRS resource set. The UE may transmit the PUSCH transmission with the one or more SRS resources indicated in the SRI.

A list or a sub-list of power control elements, e.g. SRI-based PUSCH power control (represented by SRI-PUSCH-PowerControl) elements, may be configured for the waveform, e.g. as part of the PUSCH power control configuration. For the determination of SRI-based PUSCH power control parameters, such as P0, alpha, closed-loop index, pathloss reference signal RS, the UE may use the list corresponding the current applicable waveform.

For example, the association or mapping between the list of SRI-based PUSCH power control elements to a waveform may be performed through associating this list to the SRS resource set corresponding to this waveform.

SRS resources belonging to different sets may then have different parameters or values corresponding to different waveforms such as time domain allocation, frequency domain allocation, bandwidth related parameters, sequence related parameters (such as base sequence, cyclic shift(s)), power related parameters (such as open-loop and closed-loop parameters), time bundling related parameters, SRS repetition parameters, partial-sounding-across-frequency parameters, number of (SRS) ports, etc.

FIG. 6 shows, by way of example, signalling between user equipment UE 610 and network node 620, e.g. gNB. The network node configures 611 the UE with SRS resources. The configuration may be performed as in the examples of FIG. 5 or FIG. 6. That is, the SRS resources may be configured as a single SRS resource set comprising resource subsets, or as two SRS resource sets.

The network node 620 indicates 612, to the UE 610, at least one SRS resource belonging to the first set or subset or to the second set or subset. This indication may be considered as an implicit indication of the applicable waveform for transmission. In other words, the dynamic switching of the waveform may be indicated to the UE via SRI indication, which may be carried via DCI, for example. Depending on which waveform is associated to the indicated SRS resource(s), the UE may understand whether to switch to another waveform or whether to keep the current waveform as the applicable waveform. The SRI indication may be for PUSCH transmission. The SRI values or entries, e.g. indicated via DCI, may point to one or more SRS resources belonging to the SRS resource set or subset corresponding to the current applicable waveform.

Thus, the UE 610 considers 613 the first SRS resource set or subset as active for transmission and determines the first waveform as the applicable waveform if the indicated resource(s) belong to the first SRS set or subset. The UE 610 considers 613 the second SRS resource set or subset as active for transmission and determines the second waveform as the applicable waveform if the indicated resource(s) belong to the second SRS set or subset.

The network node 620 may trigger, or activate, the SRS resource set or subset, e.g. via DCI or MAC CE. The UE 610 may understand this as an implicit indication of a waveform. That is, the UE determines the waveform corresponding to the triggered, or activated, SRS resource set or subset as the applicable waveform.

The UE 610 may transmit 614 the SRSs using the active SRS resource set or subset.

The UE 610 may transmit 615 the PUSCH transmission using/considering the active resource set or subset. The UE may transmit the PUSCH transmission with one or more SRS resources indicated in the SRI.

For example, the implicitly indicated waveform may be applicable after a predetermined time period. The predetermined time period may be, for example, defines as a UE capability. The reference point for this time period may be the ending symbol of the physical downlink control channel (PDCCH) carrying the DCI containing the SRI or triggering the SRS resource set/subset. Alternatively, the reference point may be the ending point of the PUSCH transmission triggered by the PDCCH carrying the DCI containing the SRI. Alternatively, the reference point may be the ending point of the SRS transmission triggered by the PDCCH carrying the DCI triggering the SRS resource set/subset.

As another example, the implicitly indicated waveform may be applicable for a predetermined time period, that is, during a predetermined time period.

As a further example, the implicitly indicated waveform may be applicable until receiving a new indication of a change of the waveform. This indication may be implicit or explicit indication.

SRS resources belonging to the first SRS resource set or subset may comprise or be associated with parameters corresponding to the first waveform. SRS resources belonging to the second SRS resource set or subset may comprise or be associated with parameters corresponding to the second waveform.

SRS resources may comprise or be associated with parameters corresponding to the first waveform and the second waveform such that a parameter includes a first value corresponding to the first waveform and a second value corresponding to the second waveform, wherein the apparatus is configured to apply the first value if the first waveform is the applicable waveform; or the apparatus is configured to apply the second value if the second waveform is the applicable waveform.

The parameters may be any of the following or related to any of the following: time domain allocation, frequency domain allocation, bandwidth related parameters, sequence related parameters (such as base sequence, cyclic shift(s)), power related parameters (such as open-loop and closed-loop parameters), time bundling related parameters, SRS repetition parameters, partial-sounding-across-frequency parameters, number of (SRS) ports, etc.

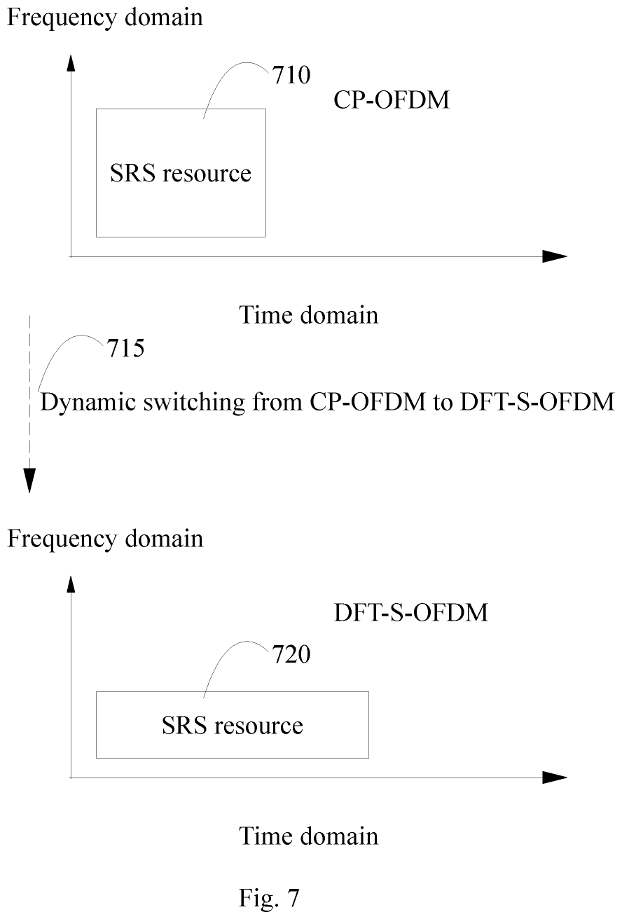

FIG. 7 shows, by way of example, sounding reference signal resource bandwidth adaptation. In the upper figure, SRS resource 710 belong to SRS resource subset or set corresponding to the CP-OFDM waveform. In this case the SRS resource bandwidth is normal or large.

After dynamic switching 715 between the waveforms, e.g. from CP-OFDM to DFT-S-OFDM, which is suitable for power-limited scenario, for example, the UE uses SRS resource 720, which belongs to an SRS resource subset or set corresponding to DFT-S-OFDM. In this case, the SRS resource bandwidth is small.

The methods as disclosed herein enable bandwidth adaptation when dynamically switching between waveforms. The methods as disclosed herein enable better channel sounding operation, because the SRS resources may be adapted for the current applicable waveform.

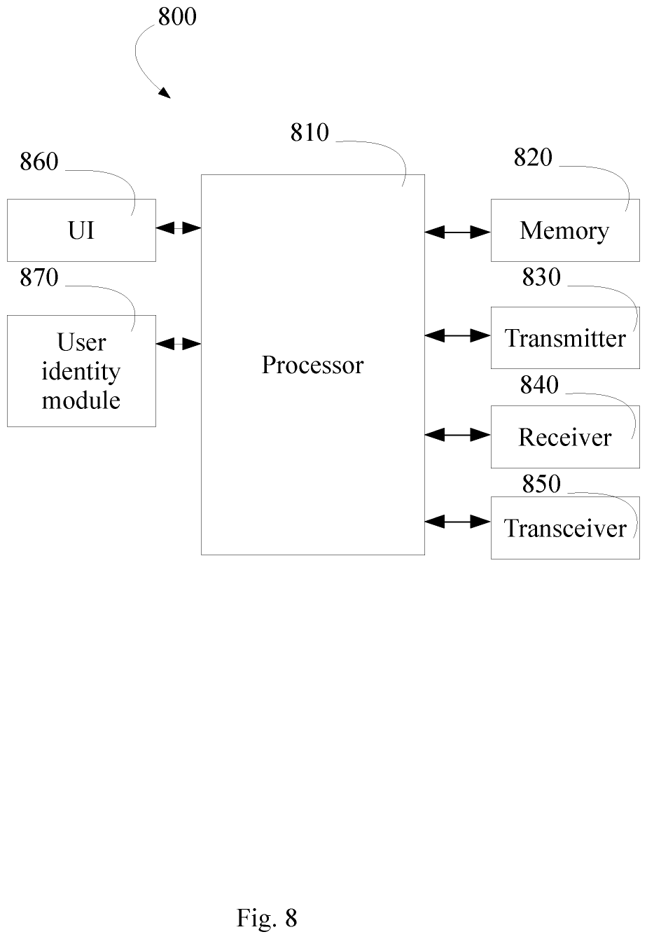

FIG. 8 shows, by way of example, an apparatus capable of performing the methods as disclosed herein. Illustrated is device 800, which may comprise, for example, a mobile communication device such as UE 410 of FIG. 4, UE 510 of FIG. 5, or UE 610 of FIG. 6, or a network node, e.g. gNB, such as the network node 420 of FIG. 4, network node 520 of FIG. 5, or network node 620 of FIG. 6. Comprised in device 800 is processor 810, which may comprise, for example, a single- or multi-core processor wherein a single-core processor comprises one processing core and a multi-core processor comprises more than one processing core. Processor 810 may comprise, in general, a control device. Processor 810 may comprise more than one processor. Processor 810 may be a control device. A processing core may comprise, for example, a Cortex-A8 processing core manufactured by ARM Holdings or a Steamroller processing core designed by Advanced Micro Devices Corporation. Processor 810 may comprise at least one Qualcomm Snapdragon and/or Intel Atom processor. Processor 810 may comprise at least one application-specific integrated circuit, ASIC. Processor 810 may comprise at least one field-programmable gate array, FPGA. Processor 810 may be means for performing method steps in device 800. Processor 810 may be configured, at least in part by computer instructions, to perform actions.

A processor may comprise circuitry, or be constituted as circuitry or circuitries, the circuitry or circuitries being configured to perform phases of methods in accordance with example embodiments described herein. As used in this application, the term “circuitry” may refer to one or more or all of the following: (a) hardware-only circuit implementations, such as implementations in only analog and/or digital circuitry, and (b) combinations of hardware circuits and software, such as, as applicable: (i) a combination of analog and/or digital hardware circuit(s) with software/firmware and (ii) any portions of hardware processor(s) with software (including digital signal processor(s)), software, and memory(ies) that work together to cause an apparatus, such as a user equipment or network node, to perform various functions) and (c) hardware circuit(s) and or processor(s), such as a microprocessor(s) or a portion of a microprocessor(s), that requires software (e.g., firmware) for operation, but the software may not be present when it is not needed for operation.

This definition of circuitry applies to all uses of this term in this application, including in any claims. As a further example, as used in this application, the term circuitry also covers an implementation of merely a hardware circuit or processor (or multiple processors) or portion of a hardware circuit or processor and its (or their) accompanying software and/or firmware. The term circuitry also covers, for example and if applicable to the particular claim element, a baseband integrated circuit or processor integrated circuit for a mobile device or a similar integrated circuit in server, a cellular network device, or other computing or network device.

Device 800 may comprise memory 820. Memory 820 may comprise random-access memory and/or permanent memory. Memory 820 may comprise at least one RAM chip. Memory 820 may comprise solid-state, magnetic, optical and/or holographic memory, for example. Memory 820 may be at least in part accessible to processor 810. Memory 820 may be at least in part comprised in processor 810. Memory 820 may be means for storing information. Memory 820 may comprise computer instructions that processor 810 is configured to execute. When computer instructions configured to cause processor 810 to perform certain actions are stored in memory 820, and device 800 overall is configured to run under the direction of processor 810 using computer instructions from memory 820, processor 810 and/or its at least one processing core may be considered to be configured to perform said certain actions. Memory 820 may be at least in part external to device 800 but accessible to device 800.

Device 800 may comprise a transmitter 830. Device 800 may comprise a receiver 840. Transmitter 830 and receiver 840 may be configured to transmit and receive, respectively, information in accordance with at least one cellular or non-cellular standard. Transmitter 830 may comprise more than one transmitter. Receiver 840 may comprise more than one receiver. Transmitter 830 and/or receiver 840 may be configured to operate in accordance with global system for mobile communication, GSM, wideband code division multiple access, WCDMA, 5G, long term evolution, LTE, IS-95, wireless local area network, WLAN, Ethernet and/or worldwide interoperability for microwave access, WiMAX, standards, for example.

Device 800 may comprise a near-field communication, NFC, transceiver 850. NFC transceiver 850 may support at least one NFC technology, such as NFC, Bluetooth, Wibree or similar technologies.

Device 800 may comprise user interface, UI, 860. UI 860 may comprise at least one of a display, a keyboard, a touchscreen, a vibrator arranged to signal to a user by causing device 800 to vibrate, a speaker and a microphone. A user may be able to operate device 800 via UI 860, for example to accept incoming telephone calls, to originate telephone calls or video calls, to browse the Internet, to manage digital files stored in memory 820 or on a cloud accessible via transmitter 830 and receiver 840, or via NFC transceiver 850, and/or to play games.

Device 800 may comprise or be arranged to accept a user identity module 870. User identity module 870 may comprise, for example, a subscriber identity module, SIM, card installable in device 800. A user identity module 870 may comprise information identifying a subscription of a user of device 800. A user identity module 870 may comprise cryptographic information usable to verify the identity of a user of device 800 and/or to facilitate encryption of communicated information and billing of the user of device 800 for communication effected via device 800.

Processor 810 may be furnished with a transmitter arranged to output information from processor 810, via electrical leads internal to device 800, to other devices comprised in device 800. Such a transmitter may comprise a serial bus transmitter arranged to, for example, output information via at least one electrical lead to memory 820 for storage therein. Alternatively to a serial bus, the transmitter may comprise a parallel bus transmitter. Likewise processor 810 may comprise a receiver arranged to receive information in processor 810, via electrical leads internal to device 800, from other devices comprised in device 800. Such a receiver may comprise a serial bus receiver arranged to, for example, receive information via at least one electrical lead from receiver 840 for processing in processor 810. Alternatively to a serial bus, the receiver may comprise a parallel bus receiver.

Processor 810, memory 820, transmitter 830, receiver 840, NFC transceiver 850, UI 860 and/or user identity module 870 may be interconnected by electrical leads internal to device 800 in a multitude of different ways. For example, each of the aforementioned devices may be separately connected to a master bus internal to device 800, to allow for the devices to exchange information. However, as the skilled person will appreciate, this is only one example and depending on the embodiment various ways of interconnecting at least two of the aforementioned devices may be selected.

1. An apparatus comprising at least one processor; and at least one memory including computer program code, the at least one memory and the computer program code configured to, with the at least one processor, cause the apparatus at least to perform:
receiving a configuration related to sounding reference signal resources comprising a first sounding reference signal resource group and a second sounding reference signal resource group, wherein the first sounding reference signal resource group is associated to a first waveform and the second sounding reference signal resource group is associated to a second waveform different from the first waveform.

2. The apparatus of claim 1, wherein the first waveform is discrete Fourier transform spread orthogonal frequency division multiplexing, DFT-S-OFDM, and the second waveform is cyclic prefix orthogonal frequency division multiplexing, CP-OFDM.

3. The apparatus of claim 1, wherein the apparatus is caused to perform:
receiving an indication related to an applicable waveform for transmission; and
transmitting at least one transmission with at least one resource comprised in the first sounding reference signal resource group if the applicable waveform is the first waveform; or
transmitting at least one transmission with at least one resource comprised in the second sounding reference signal resource group if the applicable waveform is the second waveform.

4. The apparatus of claim 3, wherein the indication indicates the applicable waveform, and the apparatus is caused to perform:
determining that the first sounding reference signal resource group is active for transmission if the first waveform is indicated as the applicable waveform; or
determining that the second sounding reference signal resource group is active for transmission if the second waveform is indicated as the applicable waveform.

5. The apparatus of claim 3, wherein the indication indicates whether the at least one resource is comprised in the first sounding reference signal resource group or in the second sounding reference signal resource group; and the apparatus is caused to perform:
determining that the first sounding reference signal resource group is active for transmission and the first waveform is the applicable waveform if the indicated at least one resource is comprised in the first sounding reference signal resource group; or
determining that the second sounding reference signal resource group is active and the second waveform is the applicable waveform if the indicated at least one resource is comprised in the second sounding reference signal resource group.

6. The apparatus of claim 4, wherein the transmission is a sounding reference signal transmission; and the apparatus is caused to perform:
receiving a trigger or an activation for at least one sounding reference signal; and
transmitting the at least one sounding reference signal with the at least one resource comprised in the active sounding reference signal resource group.

7. The apparatus of claim 4, wherein the transmission is a physical uplink shared channel, PUSCH, transmission; and the apparatus is caused to perform:
receiving scheduling information for the physical uplink shared channel transmission and an indication related to at least one sounding reference signal resource comprised in the active sounding reference signal resource group; and
transmitting the physical uplink shared channel transmission with the at least one sounding reference signal resource.

8. The apparatus of claim 1,
wherein the sounding reference signal resources are configured as a single resource set comprising the first sounding reference signal resource group and the second sounding reference signal resource group, wherein the first sounding reference signal resource group is a first resource subset and the second reference signal resource group is a second resource subset, wherein the first resource subset is associated to the first waveform and the second resource subset is associated to the second waveform.

9. The apparatus of claim 1, wherein
the sounding reference signal resources comprised in the first sounding reference signal resource group comprise or are associated with parameters corresponding to the first waveform; and
the sounding reference signal resources comprised in the second sounding reference signal resource group comprise or are associated with parameters corresponding to the second waveform.

10. The apparatus of claim 1, wherein
the sounding reference signal resources comprise or are associated with parameters corresponding to the first waveform and the second waveform such that a parameter includes a first value corresponding to the first waveform and a second value corresponding to the second waveform, wherein the apparatus is configured to apply the first value if the first waveform is the applicable waveform; or the apparatus is configured to apply the second value if the second waveform is the applicable waveform.

11. The apparatus of claim 9, wherein the parameters comprise or are related to, at least, one or more of:
time domain allocation;
frequency domain allocation;
bandwidth related parameters;
sequence related parameters;
power related parameters;
time bundling related parameters;
SRS repetition parameters;
partial-sounding-across-frequency parameters;
number of ports.

12. The apparatus of claim 1, wherein the apparatus is caused to perform:
receiving power control elements configured for the first waveform and the second waveform; and
determining the power control elements for transmission based on the applicable waveform.

13. The apparatus of claim 3,
wherein the indicated waveform is applicable after a predetermined time period.

14. The apparatus of claim 3,
wherein the indicated waveform is applicable during a predetermined time period.

15. The apparatus of claim 3,
wherein the indicated waveform is applicable until receiving an indication related to a change of the waveform.

16. (canceled)

17. A method comprising:
receiving, by a user equipment from a network node, a configuration related to sounding reference signal resources comprising a first sounding reference signal resource group and a second sounding reference signal resource group, wherein the first sounding reference signal resource group is associated to a first waveform and the second sounding reference signal resource group is associated to a second waveform different from the first waveform.

18. (canceled)

19. The method of claim 17, comprising:
receiving an indication related to an applicable waveform for transmission; and
transmitting at least one transmission with at least one resource comprised in the first sounding reference signal resource group if the applicable waveform is the first waveform; or
transmitting at least one transmission with at least one resource comprised in the second sounding reference signal resource group if the applicable waveform is the second waveform.

20. The method of claim 19, wherein the indication indicates the applicable waveform, and the method comprises:
determining that the first sounding reference signal resource group is active for transmission if the first waveform is indicated as the applicable waveform; or
determining that the second sounding reference signal resource group is active for transmission if the second waveform is indicated as the applicable waveform.

21. The method of claim 19, wherein the indication indicates whether the at least one resource is comprised in the first sounding reference signal resource group or in the second sounding reference signal resource group; and the method comprises:
determining that the first sounding reference signal resource group is active for transmission and the first waveform is the applicable waveform if the indicated at least one resource is comprised in the first sounding reference signal resource group; or
determining that the second sounding reference signal resource group is active and the second waveform is the applicable waveform if the indicated at least one resource is comprised in the second sounding reference signal resource group.

22-27. (canceled)

28. The method of claim 17, comprising:
receiving power control elements configured for the first waveform and the second waveform; and
determining the power control elements for transmission based on the applicable waveform.

29-60. (canceled)
